(19) United States
(12) Patent Application Publication
(10) Pub. No.: US 2021/0264760 A1
(43) Pub. Date: Aug. 26, 2021

(54) Unaccompanied Customer Management Application

(71) Applicant: Altitude Techs, LLC, Roscoe, IL (US)

(72) Inventor: Kerry Frank, Roscoe, IL (US)

(73) Assignee: Altitude Techs, LLC, Roscoe, IL (US)

(21) Appl. No.: 17/124,995

(22) Filed: Dec. 17, 2020

Related U.S. Application Data
(60) Provisional application No. 62/979,749, filed on Feb. 21, 2020.

(51) Int. Cl. G08B 21/02; H04W 4/024; G06Q 50/14; G01S 19/16

(52) U.S. Cl. CPC G08B 21/0269; G01S 19/16; G06Q 50/14; H04W 4/024

(57) ABSTRACT

The present invention includes a method for tracking an unaccompanied traveler during an airline travel trip. The invention includes providing applications on mobile devices related to the unaccompanied traveler, the parent/guardian, and the agent in charge of the traveler. A band is also secured to the traveler with a scannable code and which links personal information to the applications. The applications allow for current destination and status updates, text communication sessions, and other features to help ensure the safe travel of the unaccompanied traveler.

### CROSS REFERENCE TO RELATED APPLICATIONS

The current application claims priority to U.S. Provisional Application 62/979,749 filed Dec. 18, 2019, which is hereby incorporated by reference.

### BACKGROUND OF THE INVENTION

Today millions of children fly around the world without a parent or legal guardian. This is classified in the aviation industry as an Unaccompanied Minor or traveler with special needs, medical needs, or senior that needs assistance. With the increased number of divorced parents and job relocations on the rise, the trend for children to travel alone is also rising. Additionally, as our population is aging there are more seniors traveling that may need additional assistance, as well as, those with minor disabilities. There are no resources to assist such persons in marketplace today.

This software platform provides a solution to the inability for airlines and parents/guardians to have real time visibility of minors traveling by themselves (Unaccompanied Minors or UMs) and seniors that need similar assistance. The current process is literally conducted with paper and a string. When the traveler checks in at the airport, all their boarding passes for their trip are printed off, placed in a plastic envelope, which is attached to a string, and placed around the neck of the traveler. The only place the traveler gets tracked is at the points where the boarding pass regularly gets scanned—Security and the boarding gate. The parent/guardian at the departing location or the arrival location has no visibility to the traveler's location or status. The headquarters of the airline does not have visibility either. This is how children end up being delivered to the wrong cities, etc.

Numerous other advantages and features of the invention will become readily apparent from the following detailed description of the invention and the embodiments thereof, from the claims, and from the accompanying drawing

### SUMMARY OF THE INVENTION

This software platform provides a mobile application for parents/guardians, a mobile application for airline workers (ticket agents, gate agents, and flight attendants), and a web-based application for airline staff at headquarters to track and report on the status of travelers needing assistance.

### BRIEF DESCRIPTION OF THE FIGURES

A fuller understanding of the foregoing may be had by reference to the accompanying drawings, wherein:

FIG. 1 is a representation of a loading splash screen for the mobile applications. This screen can be branded for the client.

FIG. 2 is a representation of a login screen that has both the reservation number and the de-identified password filled in and is branded for the client.

FIG. 3 is a representation of the blank Traveler Profile portion of the Profile page which contains the personal information for the traveler.

FIG. 4 is a representation of the keyboard being displayed on the Traveler Profile page.

FIG. 5 is a representation of the completed Traveler Profile page.

FIG. 6 is a representation of the Traveler Profile portion filled out for a senior traveler instead of a minor.

FIG. 7 is a representation of the itinerary for the traveler.

FIG. 8 is a representation of the ability to have the flight specific information and be able to follow that flight in real time as it travels from one destination to another.

FIG. 9 is a representation of information that the parent/guardian needs to have to be ready for the departure portion of the traveler's trip.

FIG. 10 is a representation of the updated flight information with the specific detail of that flight.

FIG. 11 is a representation of the web-based dashboard available to airline headquarters staff to see all the traveler's needing assistance that are traveling the airline that day.

FIG. 12 is a representation of the ticket agent's entry screen after having entered the traveler's reservation number.

FIG. 13A is a representation of capturing the parent/guardian's signature for final agreement as to the accuracy of the traveler's information.

FIG. 13B is a representation of a wrist bracelet for an unaccompanied traveler.

FIG. 14 is a representation of scanning the bracelet to pair the bracelet being attached to the traveler's wrist with the reservation number for the traveler's trip.

FIG. 15 is a representation of the screen indicating that the bracelet has been paired with the reservation number and the ticket agent can either electronically sign, or scan their employee badge providing proof of which ticket agent took care of the traveler.

FIG. 16 is a representation of the screen indicating that everything is completed for the check-in process and the traveler is ready to continue their trip through security to the gate.

FIG. 17 is a representation of the first screen for the gate agent. They scan the bracelet of the traveler to begin the process at the gate.

FIG. 18 is a representation of the traveler's profile screen that is presented to the gate agent so they can verify all the information about the traveler and begin the transfer process to the flight attendant.

FIG. 19 is a representation of the transfer page indicating that the gate agent is boarding the traveler and transferring responsibility to the flight attendant.

FIG. 20 is a representation of the flight attendant's view of the traveler's profile page where they review all the traveler's information.

FIG. 21 is a representation of the parent/guardian app where they can see the real time status of the location of the airplane.

FIG. 22 is a representation of the parent/guardian app where they are communicating with the flight attendant that is responsible for their traveler through a chat session.

FIG. 23 is a representation of the parent/guardian app providing an updated real time location of the airplane.

FIG. 24 is a representation of the parent/guardian app chat session providing an update of the traveler's location and they have been picked up.

FIG. 25 is a representation of the flight attendant's transfer screen after they have indicated that they are delivering the traveler to the arrival contact. This screen is requesting verification of the arrival contact's ID.

FIG. 26 is a representation of the flight attendant's screen indicating travel is complete for the traveler.

FIG. 27 is a representation of the flight attendant's view of the chat session with the parent/guardian.

FIG. 28 is a representation of the flight attendant's selection of the rating for the traveler and then closing the trip.

FIG. 29 is a representation of the parent/guardian's feedback response.

FIG. 30 is a representation of the flight attendant's screen that shows them each traveler needing assistance that is assigned to their flight and under their responsibility.

FIG. 31 is a representation of the web-based dashboard showing the status of every traveler needing assistance flying that day. This dashboard is indicating that a flight has been caused to enter Irregular Operations (IROPS).

FIG. 32 is a representation of the flight attendant's app indicating that they have a traveler needing assistance that has been diverted from their original destination and needs special attention.

FIG. 33 is a representation of the flight attendant accessing the indicated traveler's profile so they can communicate with the parent/guardian in real time about what is happening with the flight and their traveler.

FIG. 34 is a representation of the flight attendant's chat screen where they are communicating with the parent/guardian about the change in travel.

FIG. 35 is a representation of this same conversation from the parent/guardian app.

FIG. 36 is a representation of the new destination being shown in the parent/guardian app.

FIG. 37 is a representation of the real time airplane location update for the diversion on the parent/guardian app.

FIG. 38 is a representation of the updated flight plans to get the traveler needing assistance to the original destination.

FIG. 39 is a representation of the chat session in the parent/guardian app where the flight attendant assigned to the traveler is updating them with the plans for the overnight stay.

FIG. 40 is a representation of the flight attendant's view of this same conversation in the chat session.

FIG. 41 is a representation of the traveler's itinerary update in the parent/guardian app.

FIG. 42 is a representation of the chat session in the parent/guardian app with the morning's plans and final trip details.

FIG. 43 is a representation of the flight attendant transferring responsibility from the overnight flight attendant to the new flight attendant assigned to the next flight.

FIG. 44 is a representation of the chat session in the flight attendant's app from the perspective of the new flight attendant taking responsibility for the traveler.

FIG. 45 is a representation of the parent/guardian app showing that the airplane has arrived at the final destination and the exact location of the airplane.

FIG. 46 is a representation of the web-based dashboard that records the top bases, flight attendants, and travelers for reward programs.

FIG. 47 is a network view of one embodiment of the invention.

### DETAILED DESCRIPTION OF THE INVENTION

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or the embodiments illustrated.

This invention includes a method, system, and/or apparatus, such as embodied in a software application. As may be used herein, a user device, a client device, a business professional device, a computing device, and/or a mobile device refer to devices corresponding to desktop computers, cellular devices or smartphones, personal digital assistants (PDAs), laptop computers, tablet devices, etc., that can provide network connectivity and processing resources for communicating with the system over one or more networks. Client devices and business professional devices can each operate a designated service application (e.g., a client application and a business professional application, respectively) that is configured to communicate with the professional service arrangement system.

The method and system of this invention is mobile and positional in nature. Such systems, like many other systems originally developed on one type of computing platform but migrated to another, operate not only on mobile environments. That is, while MPSM implementations are targeted to primarily execute on mobile devices, such as but not limited to smart-phones, tablets, and/or laptops, they often support implementation for non-mobile environments such as but not limited to desktops and workstations, servers, and large scale compute farms and cloud computing servers. The invention will be described below with a mobile device, such as smart phone having cell service, a GPS system, and access to the Internet via WiFi and/or cellular. The method and system of this invention is desirably executed or implemented on and/or through a mobile device computing platform. Such computing platforms generally include a processor, a recordable medium, an input/output (I/O) device, and a network interface capable of connecting either directly or indirectly to the Internet. The mobile device executes over a networked environment. The mobile device is connected, either directly or indirectly, using any of the many techniques and technologies known in the art, over a network, to back-end system or systems, itself/themselves computing devices. The mobile device can connect with a remote server, to store and/or access user or community information.

The system coordinates travel and may provide estimated travel time and ETA for the travel, which may be provided by the airline. User devices may interact with the system through client applications configured to interact with the system. The client applications of the user devices can present information received from the system on a user interface, such as a map of the geographic region, the current location of the user device, estimated travel duration, and/or an ETA associated with a service request. The client application executing on the user device may be able to determine the current location and provide the current location to the system. The user devices can communicate with the system via the network, which may comprise any combination of local area and wide area networks employing wired or wireless communication links. In some embodiments, all or some of the communication on the network may be encrypted.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

Depending on implementation, one or more components of the system can be implemented on network side resources, such as on one or more servers. The system can also be implemented through other computer systems in alternative architectures (e.g., peer-to-peer networks, etc.). As an addition or an alternative, some or all of the components of the system can be implemented on client devices, such as through applications that operate on the client devices and/or the business professional devices. For example, a client service application that runs on the respective client device and/or a business professional service application can execute to perform one or more of the processes described by the various components of the system. The system can communicate over a network, via a network interface (e.g., wirelessly or using a wireline), to communicate with the one or more client devices and the one or more business professional devices.

The system can communicate, over one or more networks, with client devices and business professional devices using a client device interface and a device interface, respectively. The device interfaces can each manage communications between the system and the respective computing devices. The client devices and the business professional devices can individually operate client service applications and business professional service applications, respectively, that can interface with the device interfaces to communicate with the system. According to some examples, these applications can include or use an application programming interface (API), such as an externally facing API, to communicate data with the device interfaces. The externally facing API can provide access to the system via secure access channels over the network through any number of methods, such as web-based forms, programmatic access via RESTful APIs, Simple Object Access Protocol (SOAP), remote procedure call (RPC), scripting access, etc.

This software platform provides the ability for travelers that need assistance during their public transportation trips to be tracked electronically at each point during their trip. It allows back and forth communication with those concerned about their loved one traveling and the company providing the travel service. The information gets shared with all parties responsible for assisting these travelers. This example focuses on airlines; however, it could be used for other forms of public transportation such as buses or trains.

It is designed for those individuals that require or would like supervision during their trip. Examples of these individuals are Unaccompanied Minors (minor children traveling by themselves), Seniors, travelers with disabilities, or just nervous travelers that desire extra help. The traveler, guardian, and airline employees will all utilize this application through a mobile device. The office staff at the airline will be able to monitor and report status of an individual traveler or the program, through a web-based reporting dashboard accessible through any internet browser. The figures used in this document are branded for an Airlines, however, each company can customize the look of the application with their corporate colors and logo. All figures referenced in the description are in the Appendix. The platform will also be integrated with one or more software platforms the airline already utilizes to pass data. Such data will include, but is not limited to, name, password, reservation number, user preferences, etc.

Traveler Assistance Process:

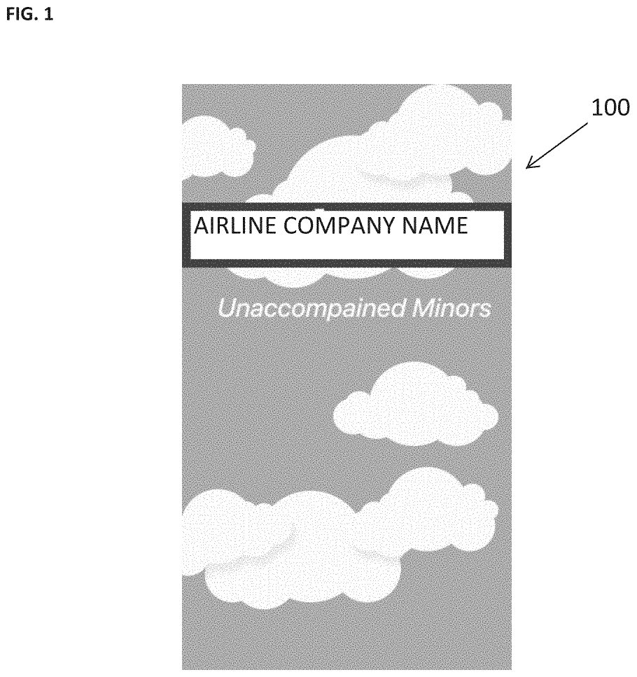

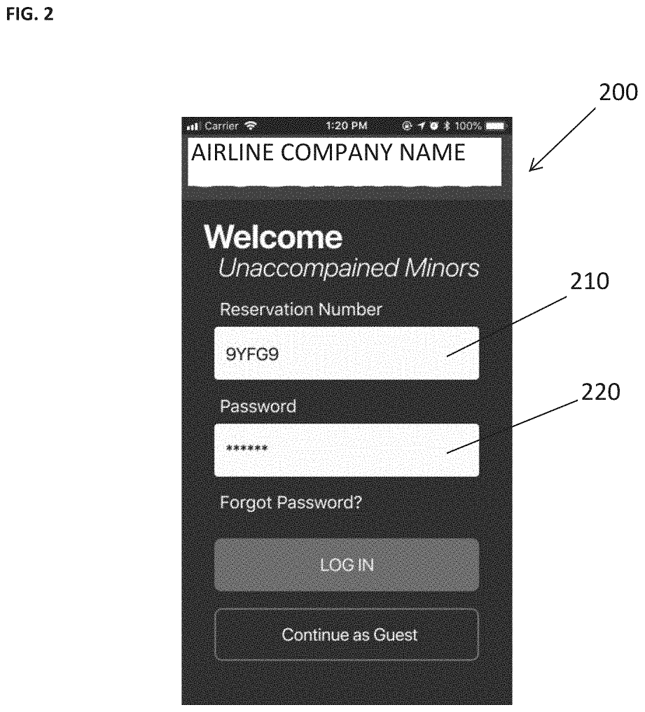

Once a ticket is purchased through the airline, the individual choosing to use this service typically, a parent/guardian or an adult child for a senior (we will use Guardian for adult child in the rest of the document), can select adding this service. Airlines can charge additional money for this service to drive more revenue. They will be directed to an application. From their mobile device, they will download the application from the app store. They only need to do this one time. After the initial download, the application is accessible from their device. When they tap on the application's icon to launch the app, the user will see a branded splash screen 100 (FIG. 1) while the application loads and syncs any data from the cloud specific to that user. When the application loads, the user will see a login screen 200 (FIG. 2). The user will enter the Reservation number assigned by the airline when the ticket was purchased 210 (FIG. 2). They will next enter their password 220 (FIG. 2).

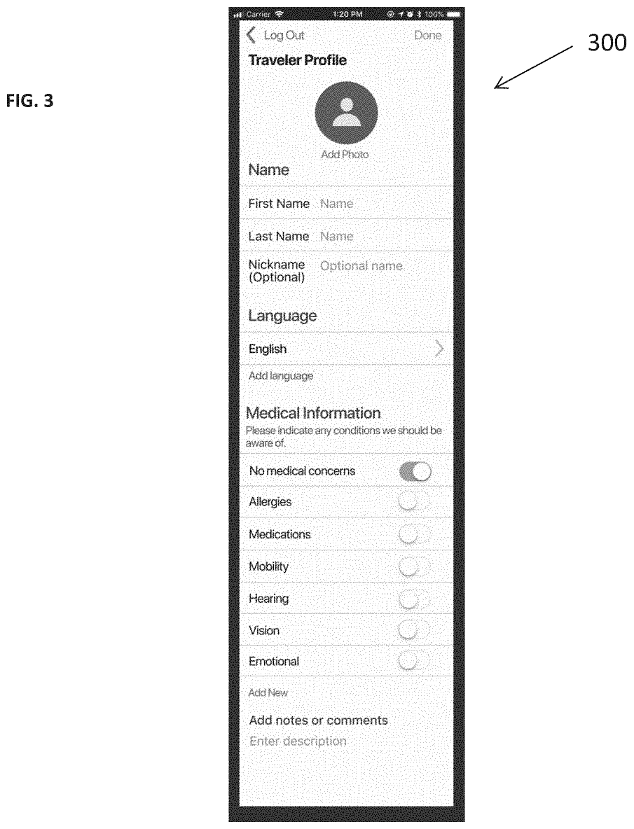

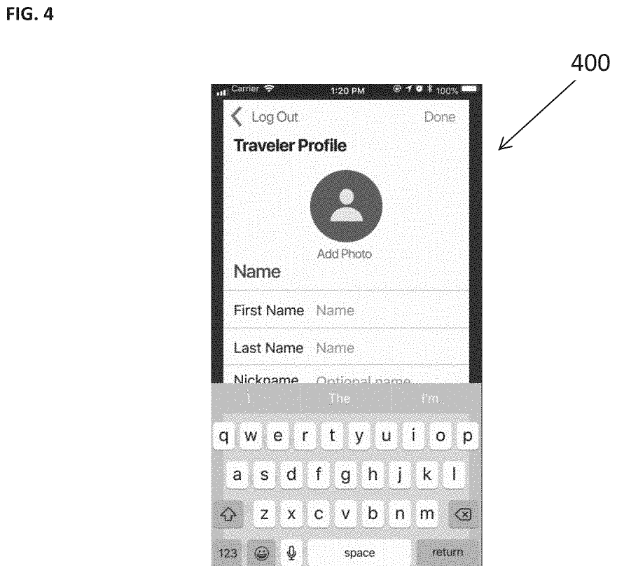

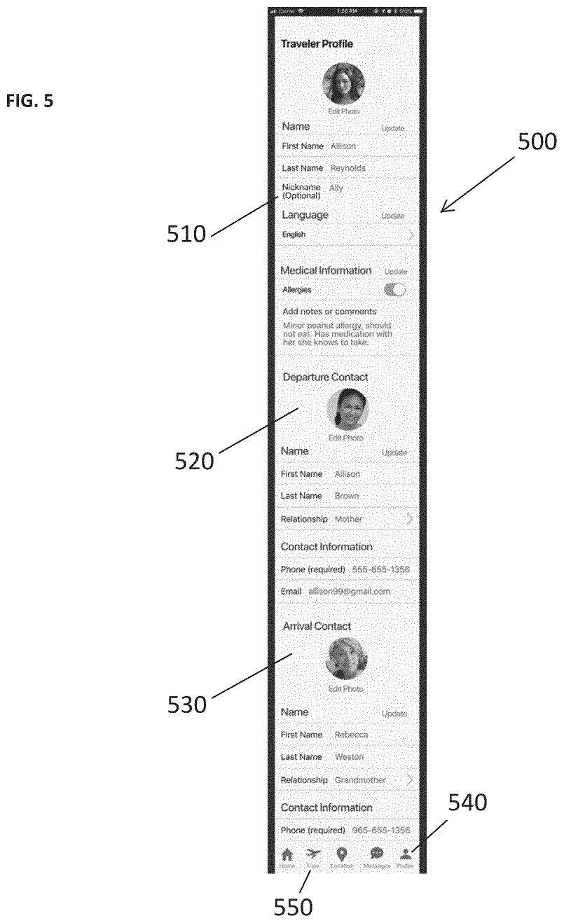

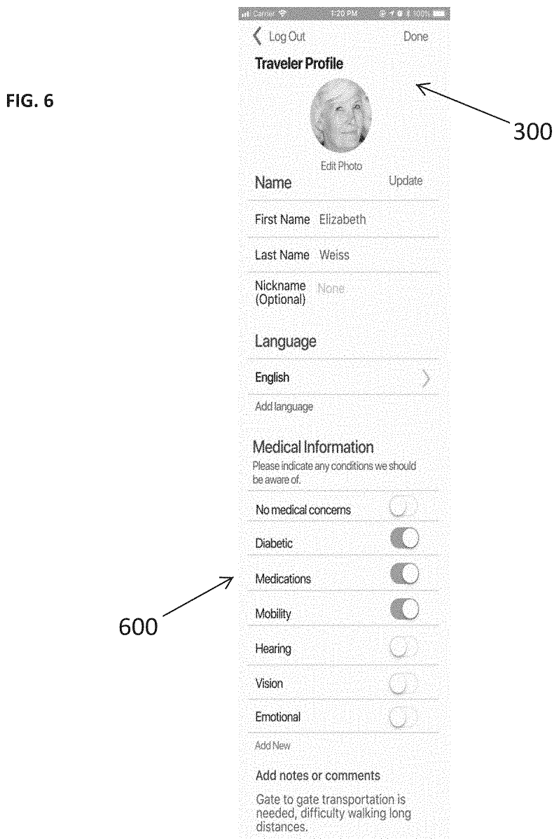

Upon use for the first time, the user will be taken to the profile screen 300 (FIG. 3) to fill in all the appropriate traveler data. The user will then type in the required data 400 (FIG. 4) until the entire profile for the traveler is complete 500 (FIG. 5). This includes the personal information about the traveler 510 (FIG. 5), the Departure Contact information 520 (FIG. 5), and the information for the Arrival Contact 530 (FIG. 5). This is the parent/guardian that is picking up the traveler. In the case of a Senior traveler, similar information is collected. There are additional fields for medical conditions, etc. that are more specific to Senior travelers than children 600 (FIG. 6). All this profile data can be accessed later through the profile icon on the bottom of the Home screen 540 (FIG. 5).

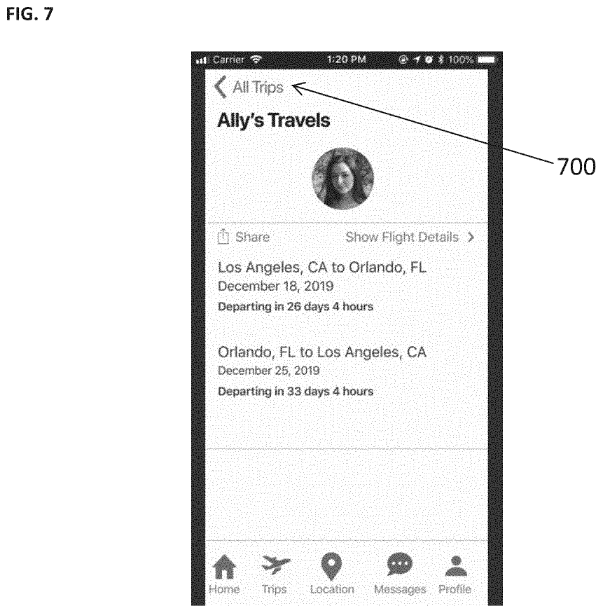

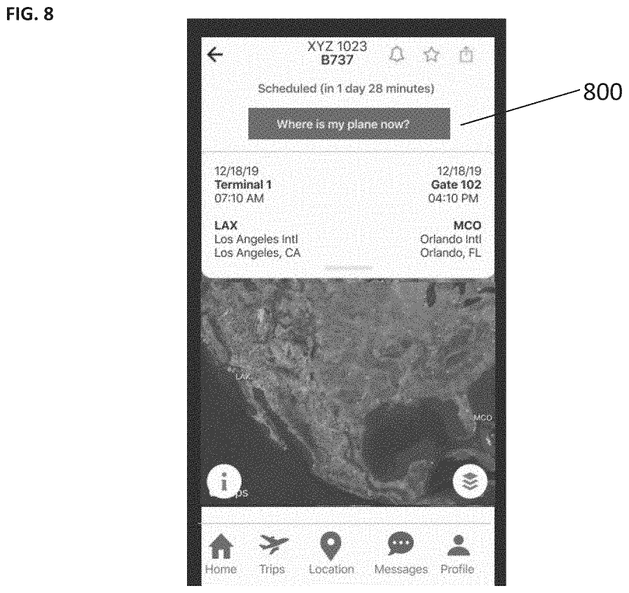

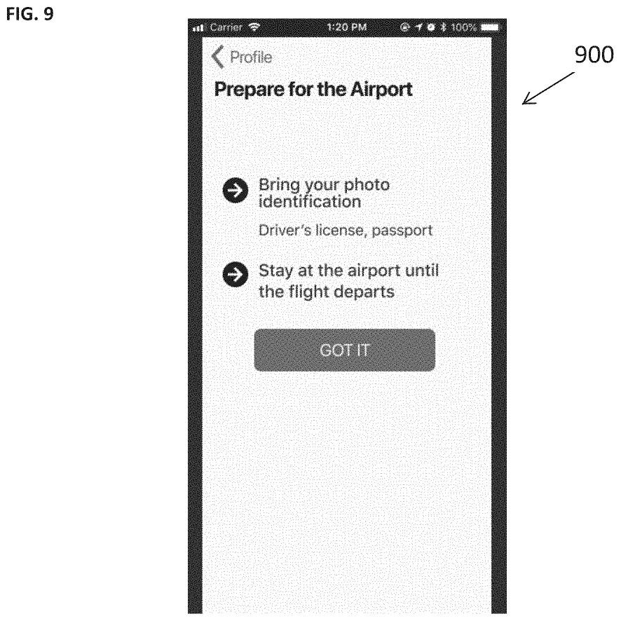

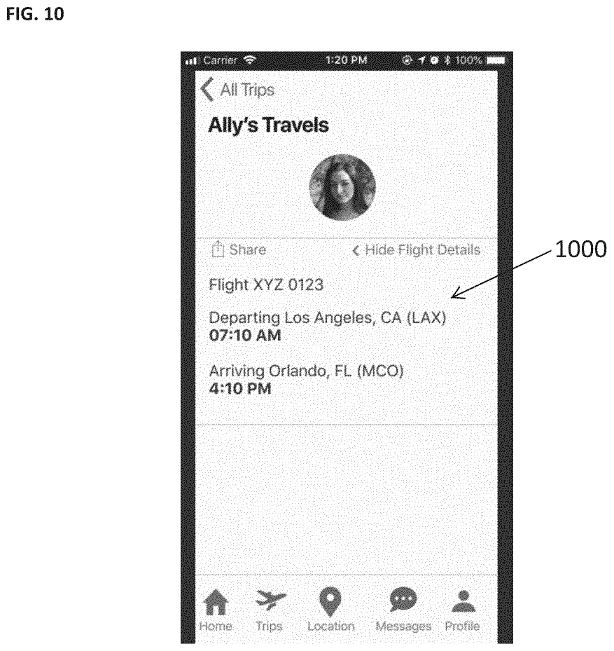

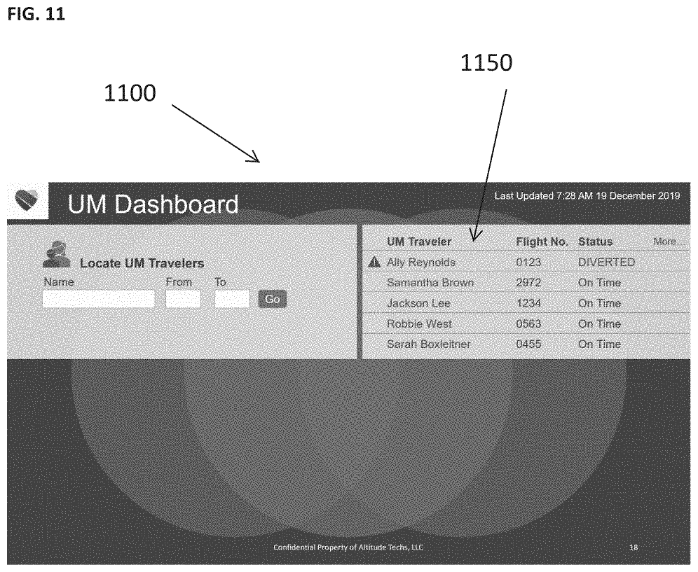

A list of upcoming trips can be accessed through the Trips icon on the Profile page 550 (FIG. 5). A list of future trips will display with all the trip details 700 (FIG. 7). As the trip gets closer to the departure date, the user can see the exact location of the airplane via an integration with a third-party application that tracks the aircraft 800 (FIG. 8). This same integration allows the parent/guardian to follow the flight during the trip as later figures will show. On the day of travel, the user will be prompted with the reminder screen in the Profile 900 (FIG. 9) of what to bring to the airport and their requirements at the airport. The user can access all the updated flight information through the Trips screen 1000 (FIG. 10). At this point, all of the travelers needing assistance that day are populated in a web-based dashboard platform 1100 and the office personnel—Dispatch, Flight Operations, Inflight (Flight Attendant) can see everyone traveling that day 1150 (FIG. 11).

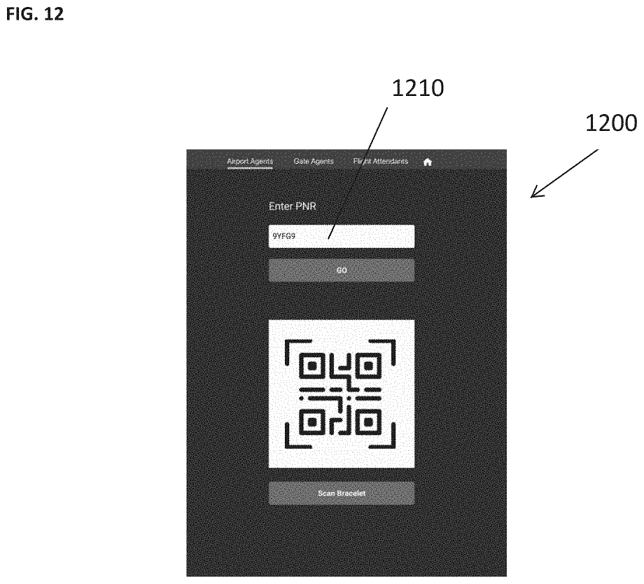

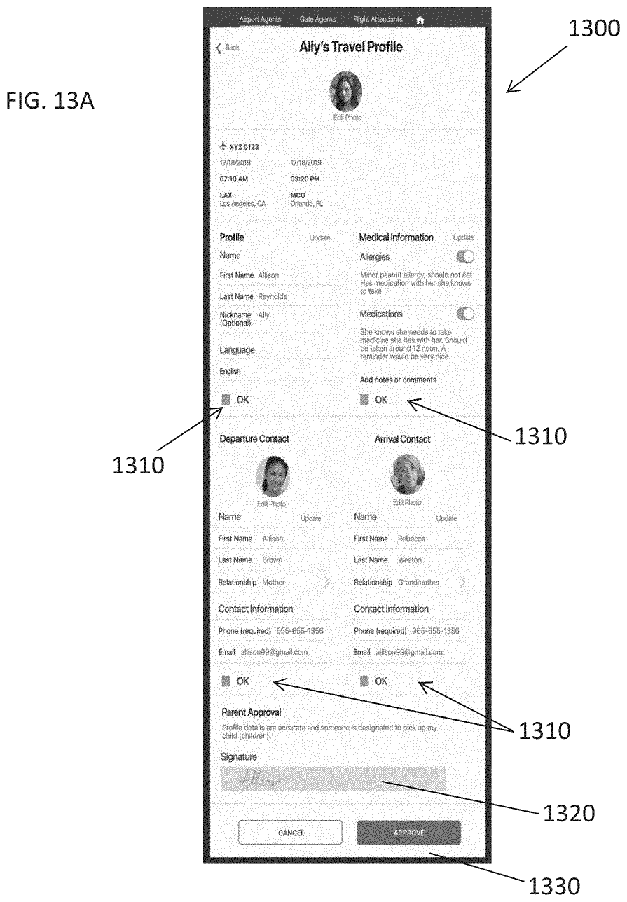

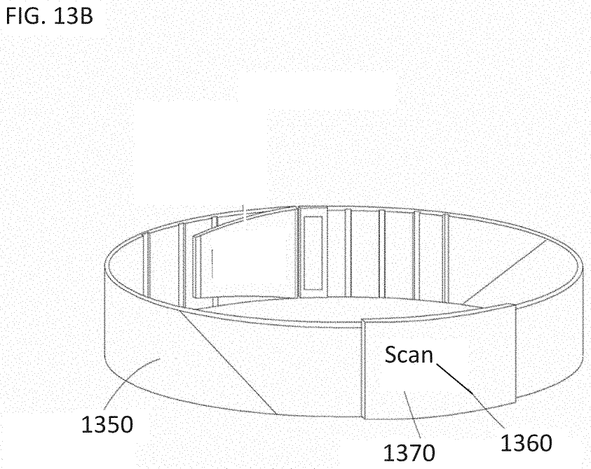

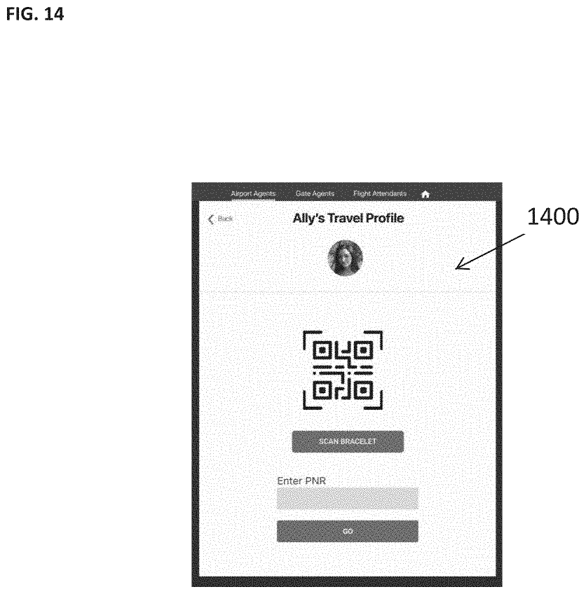

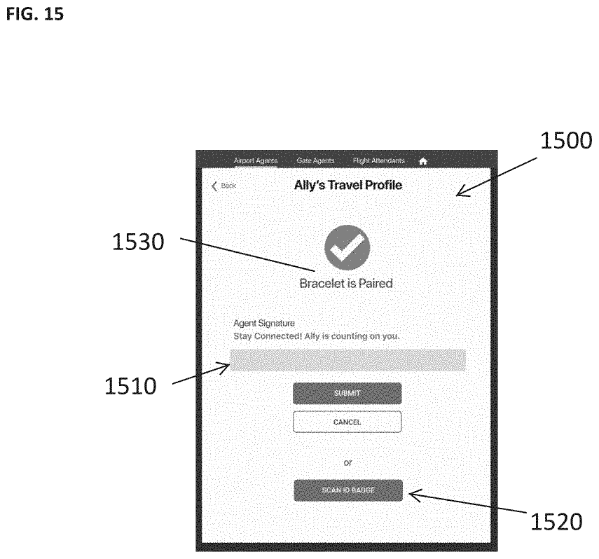

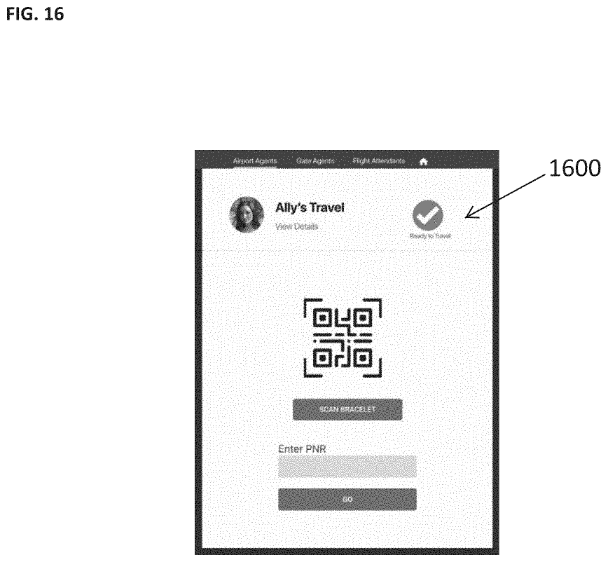

So far, everything has occurred through the parent/guardian application and in the background of the platform. We will now see how Ticket Agents, Gate Agents, and Flight Attendants interact with the process. When the traveler and their departure contact arrive at the airport, they must check in through the ticket counter as they do today. When the ticket agent checks in the traveler needing assistance, they will launch the application from their mobile device and be presented with a screen requesting the record locator number assigned to the traveler's ticket 1200 (FIG. 12). The ticket agent then enters the record locator number into the correct field 1210 (FIG. 12). After entering this number, they will be taken to the traveler's profile information 1300 (FIG. 13A). The ticket agent will have the departure contact review all the information on the profile for its accuracy. The departure contact will tap “OK” for each section 1310 (FIG. 13A). The departure contact will then sign at the bottom 1320 (FIG. 13A) and approve the information 1330. The ticket agent retrieves a bracelet 1350 (FIG. 13B) with a centered section 1360 (FIG. 13B) that includes a scannable chip or code on it 1370 (FIG. 13B), such as a QR code or RF chip, and attaches it to the traveler's wrist. The agent scans the QR code on the bracelet with their mobile device to pair the bracelet to the traveler's record locator 1400 (FIG. 14). The ticket agent is presented with a screen 1500 (FIG. 15) for them to sign 1510 (FIG. 15) or they could scan their employee ID badge 1520 (FIG. 15). When the agent is paired with the traveler, the screen will visually indicate the pairing is complete 1530 (FIG. 15). A success screen is presented indicating the check in process is complete 1600 (FIG. 16). The ticket agent provides a boarding pass for the traveler and a security access pass for the departure contact. The traveler and the departure contact proceed through TSA and go to the departure gate.

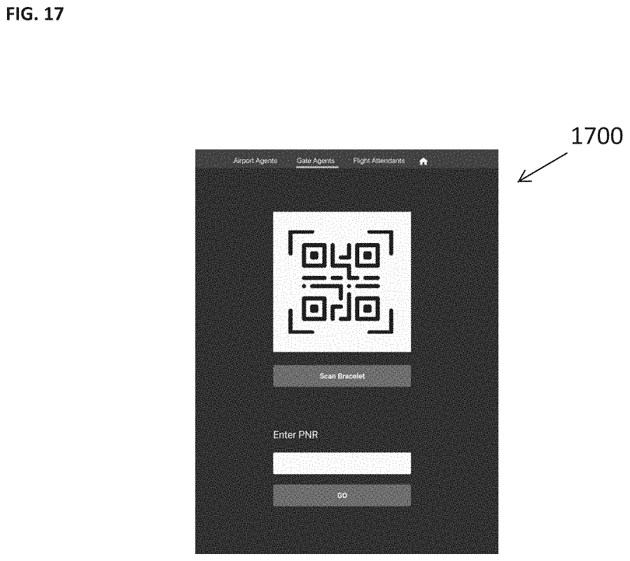

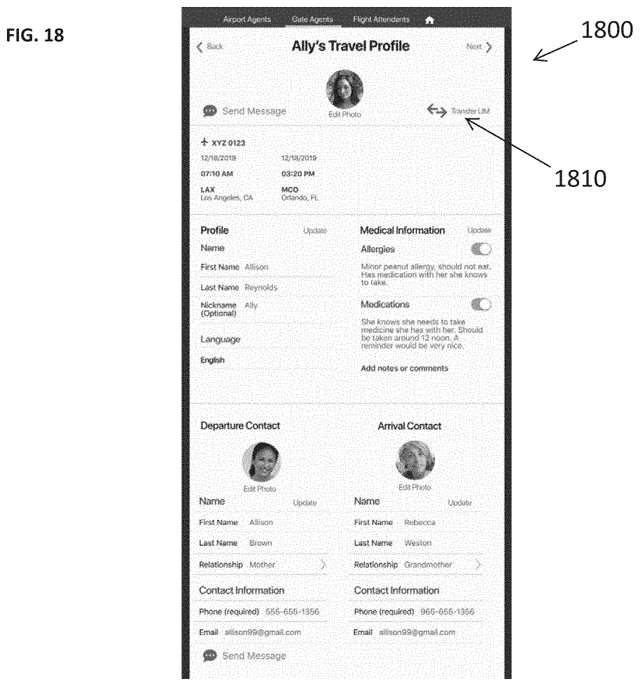

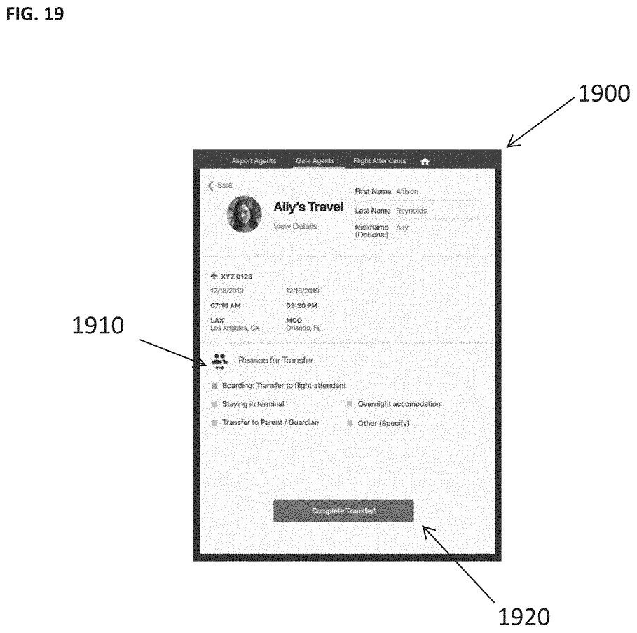

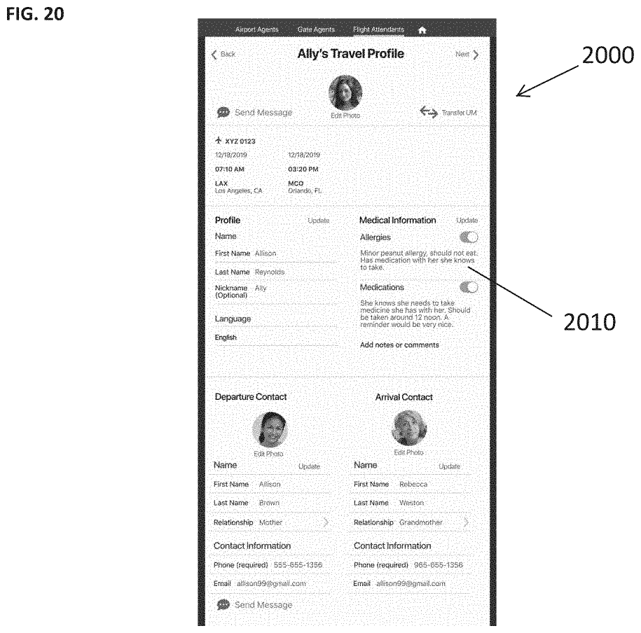

At the departure gate, the traveler is presented to the Gate Agent by the departure contact. The Gate Agent scans the traveler's bracelet with their mobile device 1700 (FIG. 17). The traveler's profile and flight information are now displayed on the agent's device 1800 (FIG. 18). At this point, the Gate Agent reviews the information with the departure contact to verify accuracy and that the traveler is at the correct gate. After this review the traveler and departure contact are asked to wait in the gate area until the aircraft is ready for boarding. When it is time to board, the Gate Agent will request the traveler to come to the desk. The Agent will scan the bracelet again 1700 (FIG. 17) to access the traveler's profile 1800 (FIG. 18). The Gate Agent takes custody of the traveler to escort them down the jetbridge as FAA regulations do not allow non-ticketed individuals beyond the terminal. At the aircraft, the Gate Agent selects “Transfer” 1810 (FIG. 18) to transfer custody of the traveler to the Flight Attendant. The Gate Agent is then presented with the Transfer screen 1900 (FIG. 19). They select the appropriate transfer reason on the transfer screen 1910 (FIG. 19). The Gate Agent selects “Complete Transfer” 1920 (FIG. 19) and the system transfers custody to the Flight Attendant and the traveler is boarded 2000 (FIG. 20).

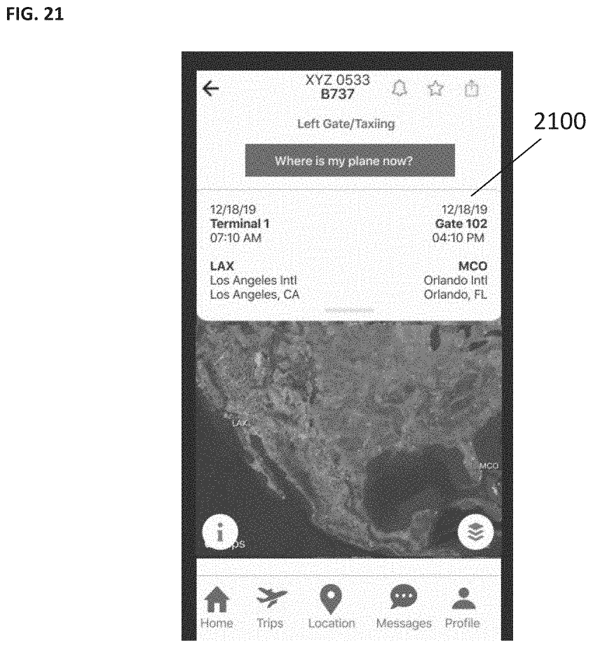

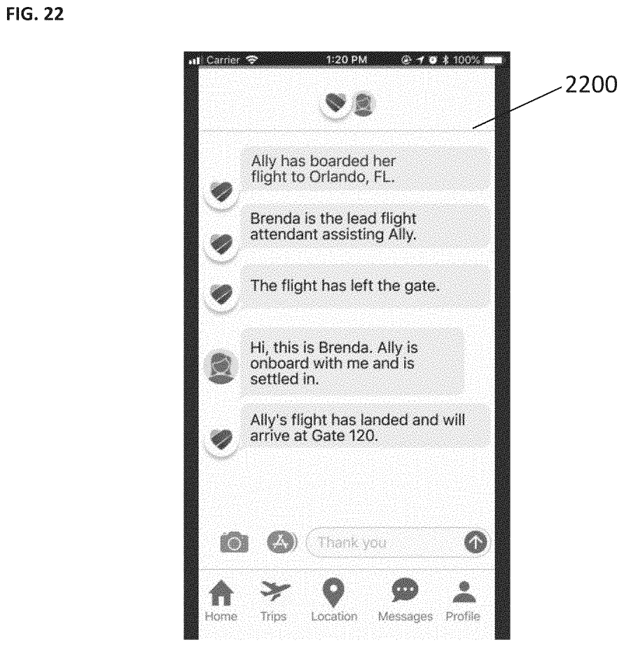

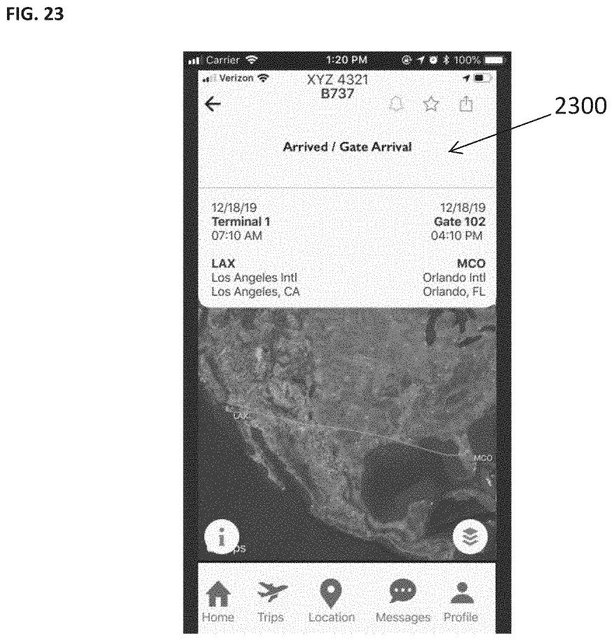

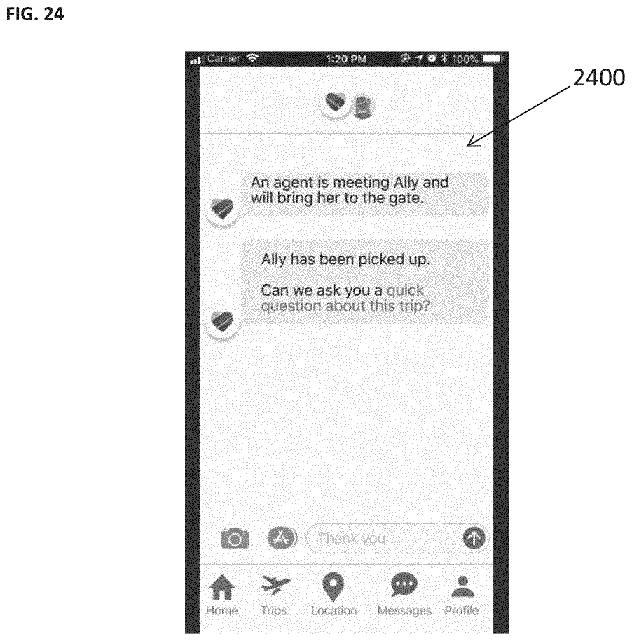

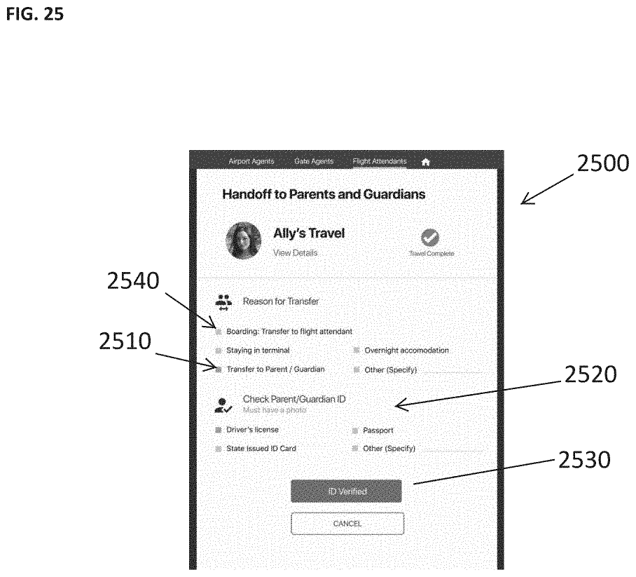

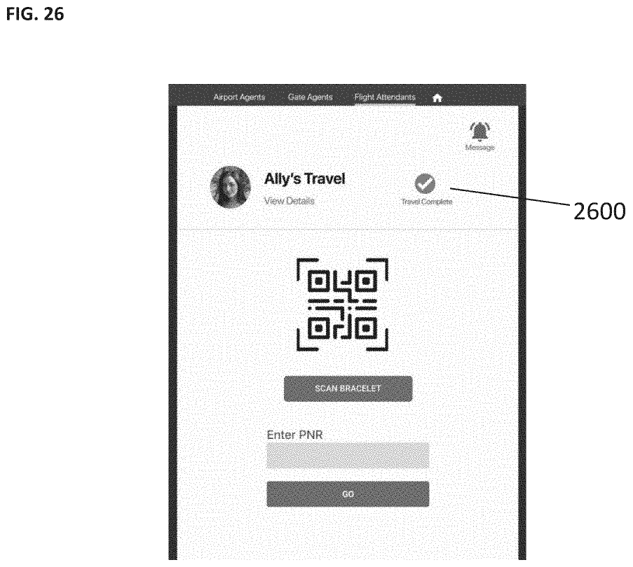

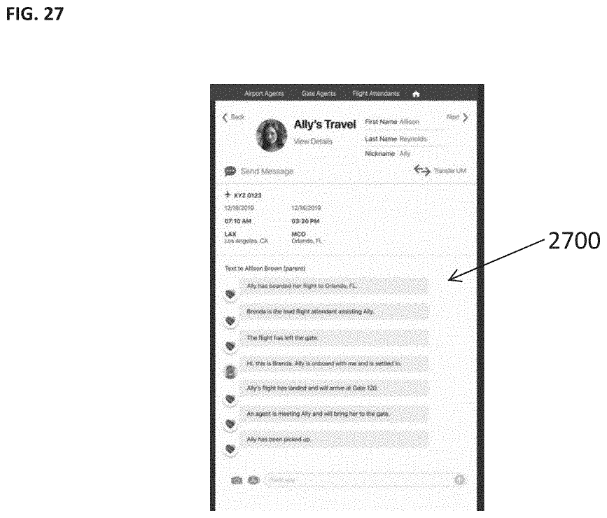

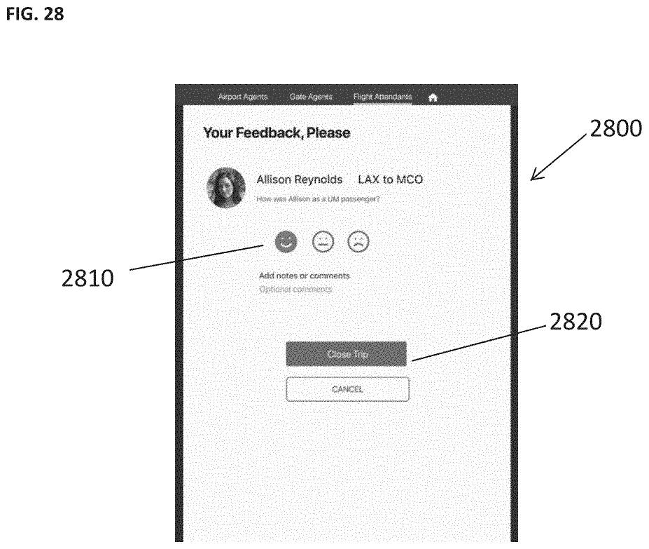

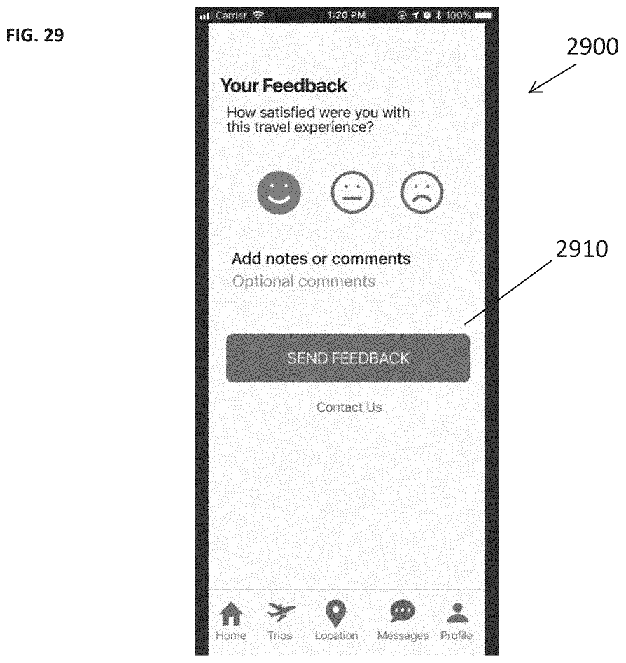

The Flight Attendant reviews the profile 2000 (FIG. 20) for any medical or other information that they will need for the traveler during the flight 2010 (FIG. 20). The Flight Attendant assists the traveler to their seat and continues to prepare for departure. When the aircraft pushes from the gate, the parent/guardian receives an update on their application of the aircraft's status and location 2100 (FIG. 21). They also receive messaging updates through the application so the responsible parties can communicate with each other 2200 (FIG. 22). Upon completion of a normal flight, the parent/guardian receives an update of the flight's arrival at its destination 2300 (FIG. 23). The messaging portion of the application continues to update of the traveler's status 2400 (FIG. 24). The Flight Attendant escorts the traveler up the jetbridge to the destination contact. The Flight Attendant selects transfer 1810 (FIG. 18) on the Profile screen to transfer custody to the arrival contact. They are then presented with the Transfer screen 2500 (FIG. 25). The Flight Attendant selects the appropriate reason for transfer 2510 (FIG. 25). They verify the ID of the destination contact and select which form of ID was presented 2520 (FIG. 25). The Flight Attendant selects the “ID Verified” button 2530 (FIG. 25) and is presented with the Travel Complete screen 2600 (FIG. 26). The Flight Attendant also has a messaging screen where they can review and input messages. The entire message string is shown 2700 (FIG. 27). The Flight Attendant is then presented with a Feedback screen where they can report on the behavior of the traveler 2800 (FIG. 28). After completing the Feedback 2810 (FIG. 28), the Flight Attendant then closes the trip by selecting the “Close Trip” button 2820 (FIG. 28). The traveler's trip is complete. The parent/guardian also has an opportunity for feedback 2900 (FIG. 29). This feedback opportunity allows the parent/guardian to report on the entire process and the airline employees involved. The completed Feedback screen is the final step of the traveler's trip 2910 (FIG. 29).

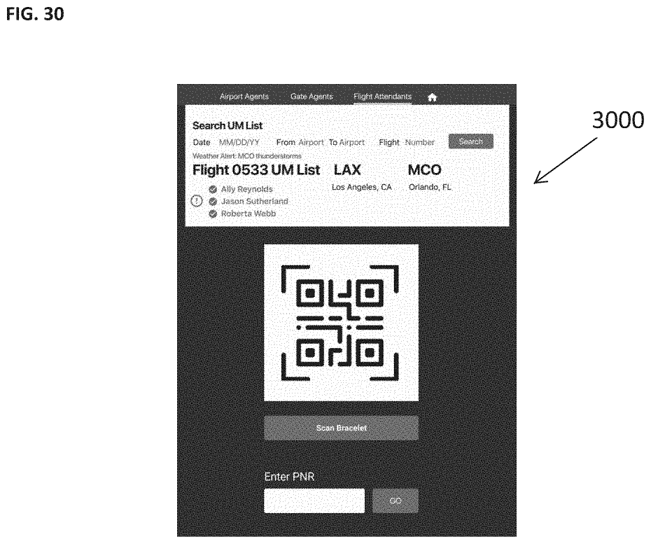

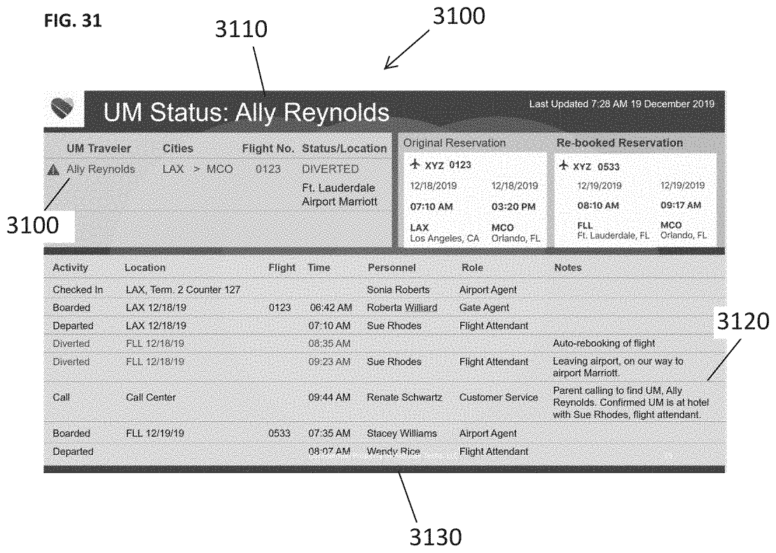

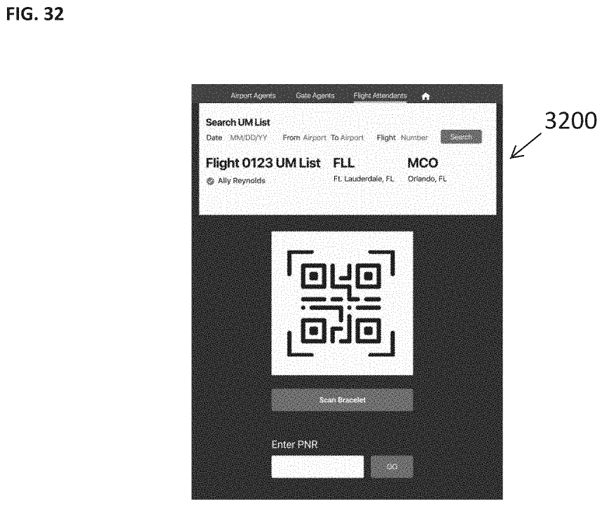

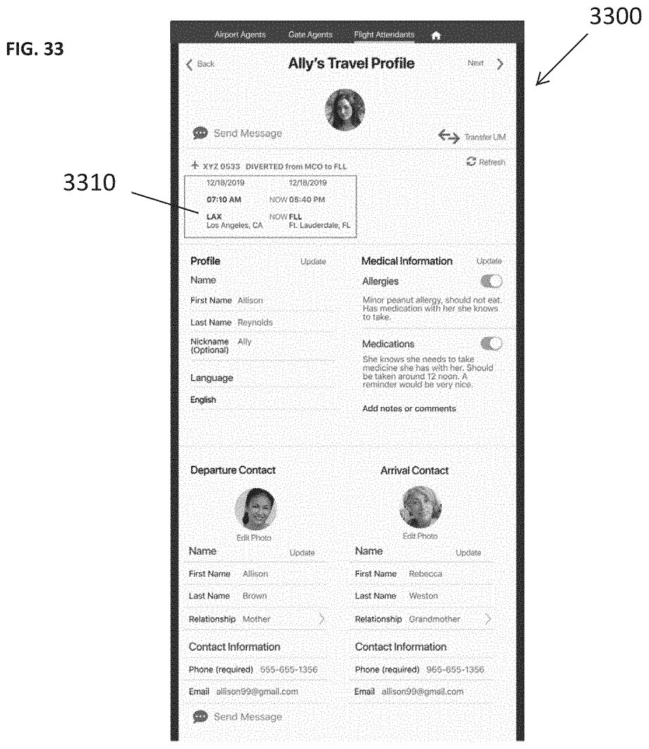

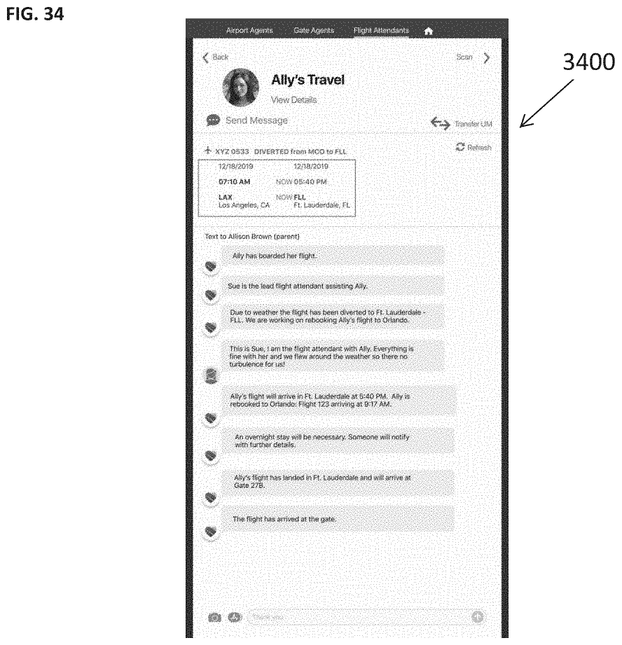

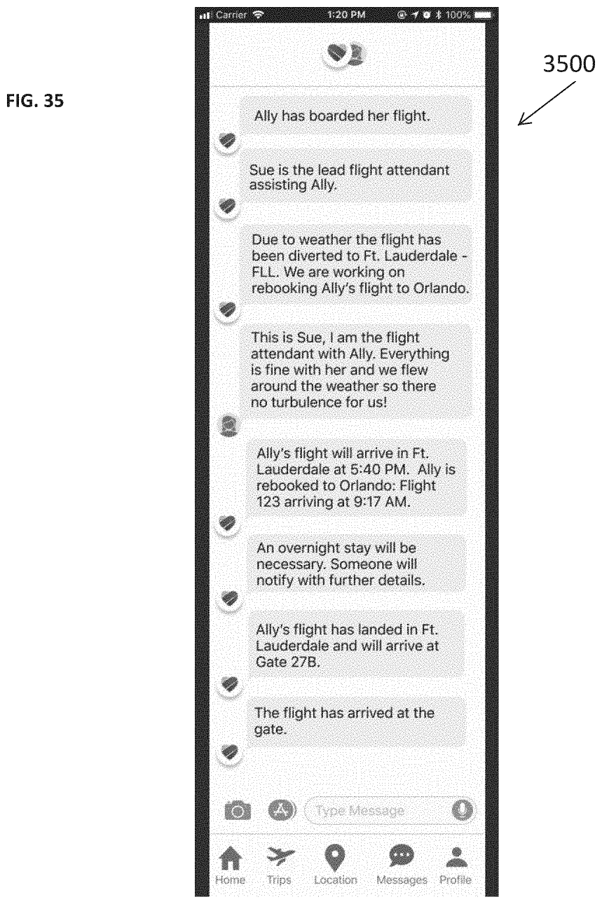

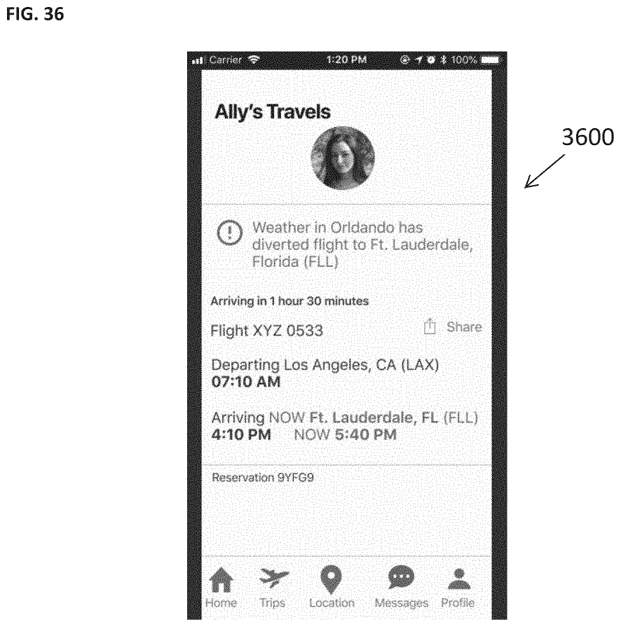

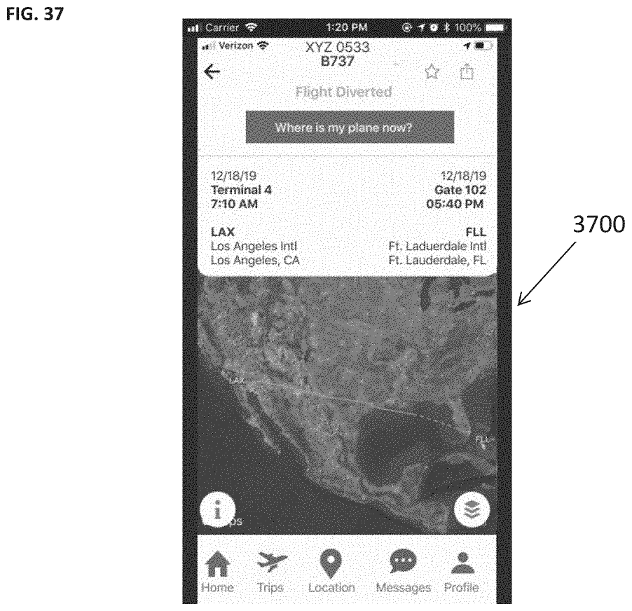

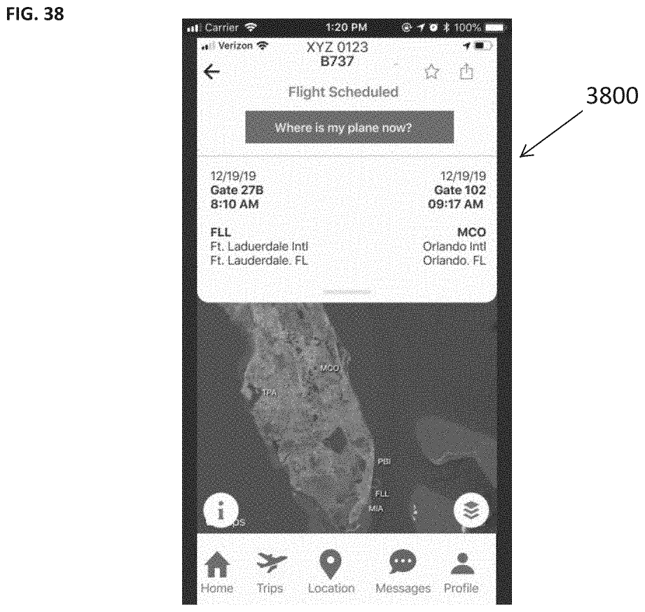

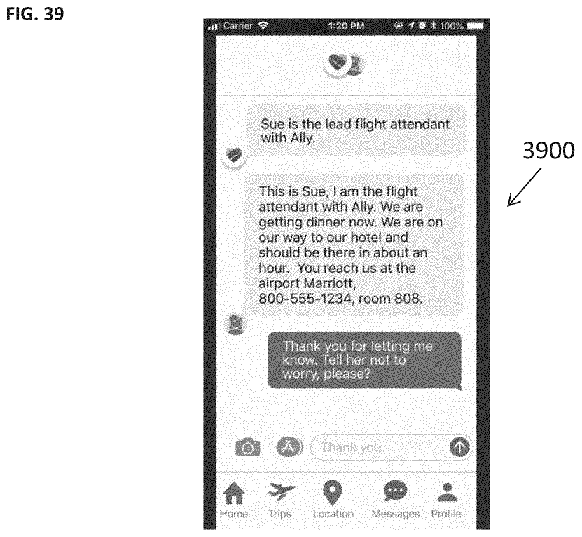

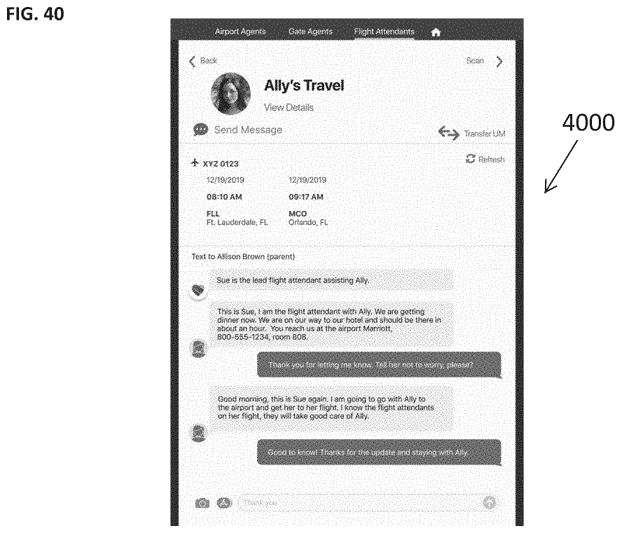

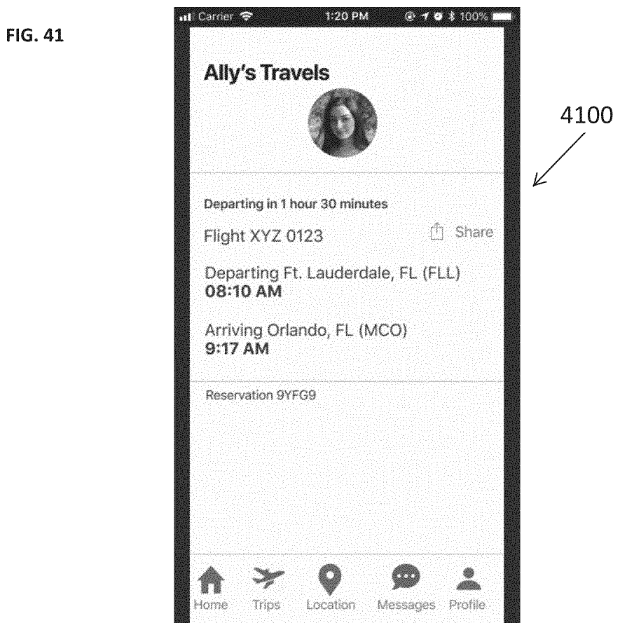

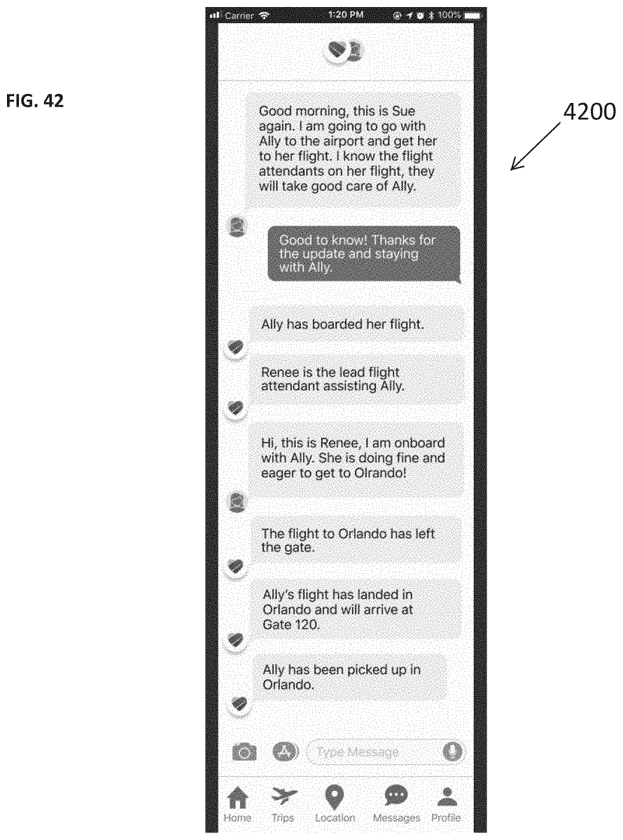

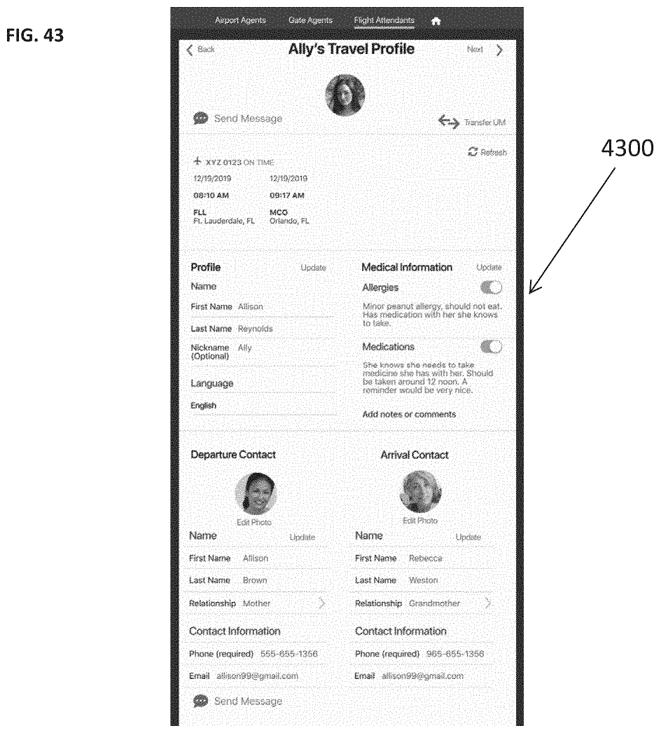

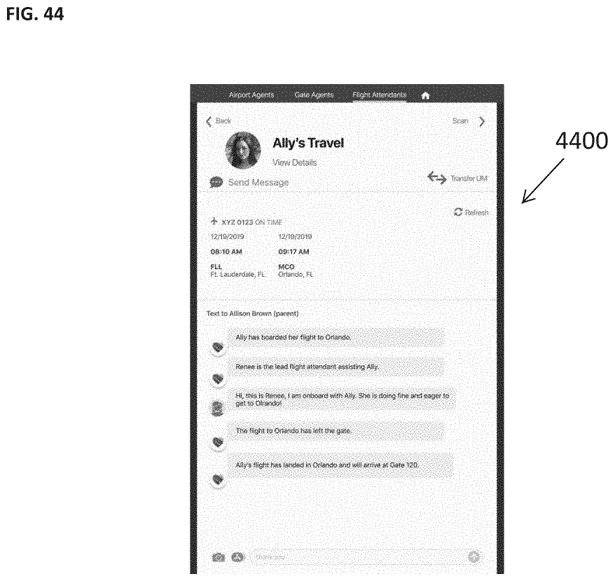

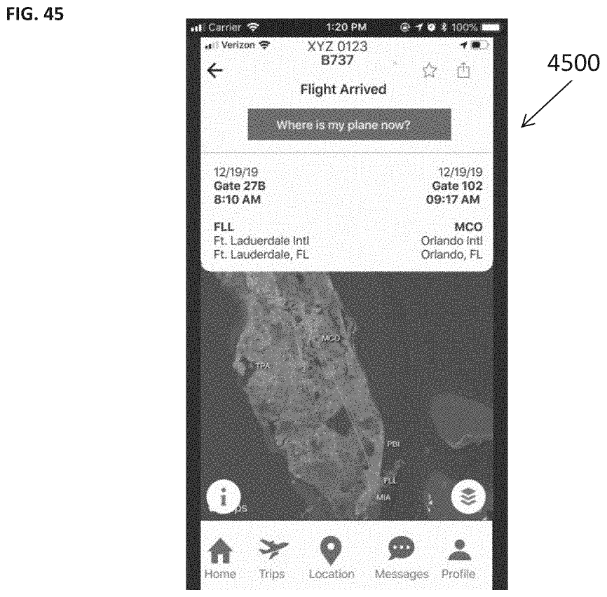

There are times when everything does not go according to plan. It could be because of a mechanical failure, weather, or any number of other reasons that cause an aircraft to change their schedule. Sometimes this occurs in the middle of a flight. These situations force the airlines to enter a phase of operation called “Irregular Operations” or “IROPS”. The IROPS situation depicted in this document is a weather event, but the same process is used in any situation that would cause the airline to go into the IROPS phase of operations. When Dispatch diverts the aircraft, the traveler assistance application is updated and the Flight Attendant's app alerts them that the traveler's connection might be affected by the delay 3000 (FIG. 30). The other departments at headquarters or the stations can track each traveler through the Dashboard 3100 (FIG. 31). They can see each traveler 3110 (FIG. 31), their current location 3120 (FIG. 31), and the airline staff member responsible for them 3130 (FIG. 31). The Flight Attendant's application is updated with each traveler's updated travel 3200 (FIG. 32). The application then opens to the traveler's profile screen 3300 (FIG. 33), and the updated flight information is displayed on the profile screen 3310 (FIG. 33). The Flight Attendant then messages the parent/guardian notifying them of the changes and what the plans are 3400 (FIG. 34). The parent/guardian can participate in the conversation through the messaging portion of their mobile application 3500 (FIG. 35). They can also see the updated flight information 3600 (FIG. 36). The parent/guardian can see a map view of the diverted flight 3700 (FIG. 37), and the next scheduled flight to get the traveler to the originally planned destination 3800 (FIG. 38). This particular situation requires an overnight stay with the traveler. In these situations, the Flight Attendant responsible accompanies the traveler to a hotel and goes back to the airport the next day with the traveler. The Flight Attendant can update the parent/guardian of the overnight plans through the messaging portion of the mobile application 3900 (FIG. 39) and on the Flight Attendant's application 4000 (FIG. 40). The next day, the parent/guardian can see the status of the flight from the diverted airport to the original destination 4100 (FIG. 41). The Flight Attendant accompanies the traveler to the airport and escorts them to the next flight. They can continue the conversation in the messaging portion of the application to keep the parent/guardian up to date 4200 (FIG. 42). The Flight Attendant from the overnight, transfers the traveler to the new Flight Attendant just as they did with the destination contact in the first scenario. The Flight Attendant selects transfer 1810 (FIG. 18) on the Profile screen to transfer custody to the arrival contact. They are then presented with the Transfer screen 2500 (FIG. 25). The Flight Attendant selects the appropriate reason for transfer 2540 (FIG. 25). The new Flight Attendant accepts the transfer and reviews the traveler's profile 4300 (FIG. 43). This Flight Attendant reviews the conversation in the messaging area to get familiar with the events of this traveler's journey and adds to the conversation introducing themselves and that the traveler is now with them 4400 (FIG. 44). The final flight of this journey was uneventful, and the parent/guardian sees that the flight has landed as planned 4500 (FIG. 45). Just as in Regular Operations, the Flight Attendant escorts the traveler up the jetbridge to the arrival contact. The Flight Attendant selects transfer 1810 (FIG. 18) on the Profile screen to transfer custody to the arrival contact. They are then presented with the Transfer screen 2500 (FIG. 25). The Flight Attendant selects the appropriate reason for transfer 2510 (FIG. 25). They verify the ID of the destination contact and select which form of ID was presented 2520 (FIG. 25). The Flight Attendant selects the “ID Verified” button 2530 (FIG. 25) and is presented with the Travel Complete screen 2600 (FIG. 26). The Flight Attendant is then presented with a Feedback screen where they can report on the behavior of the traveler 2800 (FIG. 28). After completing the Feedback 2810 (FIG. 28), the Flight Attendant then closes the trip by selecting the “Close Trip” button 2820 (FIG. 28). The traveler's trip is complete. The parent/guardian also has an opportunity for feedback 2900 (FIG. 29). This feedback opportunity allows the parent/guardian to report on the entire process and the airline employees involved. The completed Feedback screen is the final step of the traveler's trip 2910 (FIG. 29).

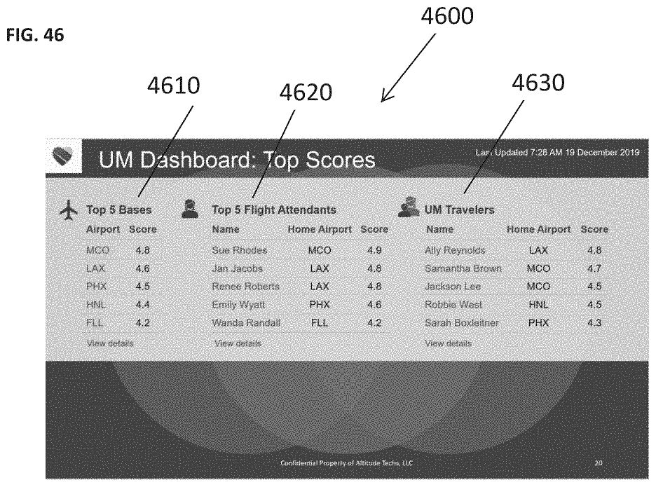

With the feedback, this will create some gamification for airline employees to give incredible service to receive top ratings as well as children to be on their best behavior and get top ratings from the flight attendant. Airlines can then create rewards systems for top travelers. The headquarters departments can report on various metrics via the web-based Dashboard 4600 (FIG. 46), including but not limited to—Top-rated stations 4610 (FIG. 46), Top-rated Flight Attendants 4620 (FIG. 46), and Top-rated travelers 4630 (FIG. 46).

Other dashboards will be imperative for Dispatch to have real time access to how many travelers needing assistance are on board each flight. This could impact their decision on which flights to delay, minimizing impact to flights that have lots of travelers needing assistance on board.

Today this service is only offered to children flying alone and is done with paper and a string around the child's neck. The airline cannot track real time chain of custody and at times have “lost” children. We hope our solution will help children have the safest travel experience and we believe that this service should be expanded to seniors, those with minor disabilities, and nervous travelers.

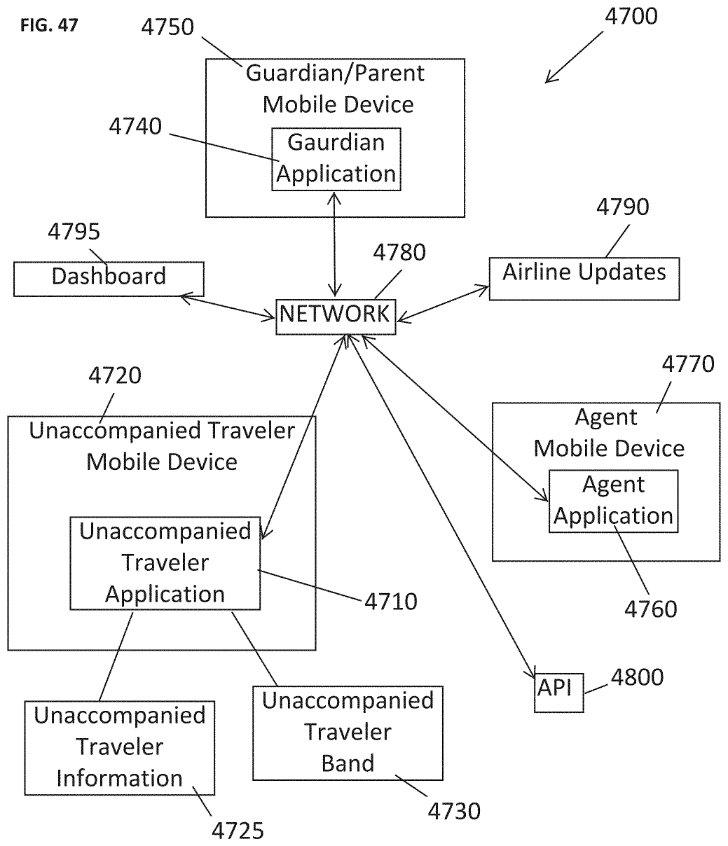

Referring now to FIG. 47, there is providing a system and method of tracking an unaccompanied traveler 4700. This includes providing an unaccompanied traveler application 4710 configured for storage on a first mobile device 4720 related to the unaccompanied traveler, and wherein the unaccompanied traveler application further configured to store traveler information 4725 about the unaccompanied traveler including, but not limited to, personal identification information and a travel itinerary. A band 4730 to secure to the unaccompanied traveler and the band has a scannable code with an unique identification associated with the unaccompanied traveler. In addition, a guardian traveler application 4740 is configured for storage on a second mobile device 4750 related to a parent/guardian related to the unaccompanied traveler. Further, an agent traveler application 4760 is configured for storage on one or more agent mobile devices 4770 related to an agent in charge of monitoring the unaccompanied traveler, and wherein the agent traveler application further comprising scanning the band to identify the unaccompanied traveler and linking the agent traveler application to the unaccompanied traveler. The applications are all in communication to a network system 4780 to allow text communication sessions on each of the unaccompanied traveler application, guardian traveler application, and the agent traveler application for linking the mobile devices together. The network also provides destination updates 4790 provided by the airlines on each of the unaccompanied traveler application, guardian traveler application and the agent traveler application for monitoring the airline travel trip. In addition, a dashboard 4795 can be provided for real time reports and updates to the system. In addition, these applications can include or use an application programming interface (API) 4800, as explained above.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

We claim:

1. A method for tracking an unaccompanied traveler during an airline travel trip comprising:
providing an unaccompanied traveler application configured for storage on a first mobile device related to the unaccompanied traveler, and wherein the unaccompanied traveler application further configured to store traveler information about the unaccompanied traveler including, but not limited to, personal identification information and a travel itinerary;
providing a band to secure to the unaccompanied traveler, the band having a scannable code with an unique identification associated with the unaccompanied traveler;
providing a guardian traveler application configured for storage on a second mobile device related to a parent/guardian related to the unaccompanied traveler;
providing an agent traveler application configured for storage on one or more agent mobile devices related to an agent in charge of monitoring the unaccompanied traveler, and wherein the agent traveler application further comprising scanning the band to identify the unaccompanied traveler and linking the agent traveler application to the unaccompanied traveler;
providing a text communication session on each of the unaccompanied traveler application, guardian traveler application, and the agent traveler application for linking the mobile devices; and
providing destination updates on each of the unaccompanied traveler application, guardian traveler application and the agent traveler application for monitoring the airline travel trip.

2. The method of claim 1 wherein the unaccompanied traveler application further configured to store traveler information about the unaccompanied traveler including, but not limited to, traveler medical information.

3. The method of claim 1 further comprising:
providing updates by a communication network to each of the unaccompanied traveler application, guardian traveler application, and the agent traveler application and wherein the updates include, but are not limited to, airline information, gate information, time of departure, time of arrival corresponding to the airline travel trip of the unaccompanied traveler.

4. The method of claim 3 further comprising providing GPS tracking on each of the unaccompanied traveler application, guardian traveler application, and the agent traveler application to correspond to a current location of the unaccompanied traveler during the airline travel trip.

5. The method of claim 3, wherein the agent traveler application is further configured to communicate between two or more agent mobile devices a transfer of monitoring the unaccompanied traveler from one agent to another agent when the unaccompanied traveler boards or departs an airplane.

6. The method of claim 5 further comprising:
providing a network dashboard to monitor and report a current status of the unaccompanied traveler and reporting the current status to the guardian traveler application.

7. The method of claim 6 further comprising:
providing an airline update to one or more of the unaccompanied traveler application, guardian traveler application, and the agent traveler application when the airline travel trip includes a diversion, late departure, early arrival, or change during a flight.

8. A system to track an unaccompanied traveler during an airline travel trip comprising:
an unaccompanied traveler application configured for storage on a first mobile device related to the unaccompanied traveler, and wherein the unaccompanied traveler application further configured to store traveler information about the unaccompanied traveler including, but not limited to, personal identification information and a travel itinerary;
a band to secure to the unaccompanied traveler, the band having a scannable code with an unique identification associated with the unaccompanied traveler;
a guardian traveler application configured for storage on a second mobile device related to a parent/guardian related to the unaccompanied traveler;
an agent traveler application configured for storage on one or more agent mobile devices related to an agent in charge of monitoring the unaccompanied traveler, and wherein the agent traveler application further configured to scan the band to identify the unaccompanied traveler and link the agent traveler application to the unaccompanied traveler application and unaccompanied traveler;
a text communication session on each of the unaccompanied traveler application, guardian traveler application, and the agent traveler application to link the mobile devices together; and
and wherein each of the unaccompanied traveler application, guardian traveler application, and the agent traveler application being further configured to receive destination updates to monitor the airline travel trip.

9. The system of claim 8 wherein the unaccompanied traveler application further configured to store traveler information about the unaccompanied traveler including, but not limited to, traveler medical information.

10. The system of claim 8 further comprising:
a communication network configured to provide to each of the unaccompanied traveler application, guardian traveler application, and the agent traveler application updates including, but are not limited to, airline information, gate information, time of departure, time of arrival corresponding to the airline travel trip of the unaccompanied traveler.

11. The system of claim 10 further comprising GPS tracking on each of the unaccompanied traveler application, guardian traveler application, and the agent traveler application to correspond to a current location of the unaccompanied traveler during the airline travel trip.

12. The system of claim 10, wherein the agent traveler application is further configured to communicate between two or more agent mobile devices a transfer of monitoring the unaccompanied traveler from one agent to another agent when the unaccompanied traveler boards or departs an airplane.

13. The system of claim 12 further comprising:
a network dashboard to monitor and report a current status of the unaccompanied traveler and reporting the current status to the guardian traveler application.

14. The system of claim 13 wherein the network dashboard is further configured to send an airline update to one or more of the unaccompanied traveler application, guardian traveler application, and the agent traveler application when the airline travel trip includes a diversion, late departure, early arrival, or change during a flight.
